(19) United States
(12) Patent Application Publication
(10) Pub. No.: US 2007/0074090 A1
(43) Pub. Date: Mar. 29, 2007

(54) System, method and device of controlling the activation of a processor

(76) Inventor: Solomon B. Trainin, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/236,574

(22) Filed: Sep. 28, 2005

(51) Int. Cl. H04L 1/00

(52) U.S. Cl. 714/746; 709/225; 714/748; 710/240

(57) ABSTRACT

Embodiments of the present invention provide a method, apparatus and system of controlling the activation of a processor. The apparatus, according to some demonstrative embodiments of the invention, may include an activation controller to allow a processor to be in an inactive state of operation during at least a portion of a permitted transmission time period in which the processor is permitted to process a transmission over a wireless communication channel. Other embodiments are described and claimed.

### BACKGROUND OF THE INVENTION

In wireless communication networks, a wireless communication station may include a processor to process the transmission of one or more frames.

The processor may manage a prioritization mechanism, e.g., an Enhanced Distributed Channel Access (EDCA) prioritizing mechanism, for prioritizing the transmission of one or more frames. The prioritizing mechanism may relate to a plurality of queues, each characterized by a plurality of timing parameters, e.g., an Arbitration Inter Frame Space (AIFS) period, first and second Contention Window (CW) values, and a random back-off period corresponding to the first and second CWs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic diagram of a wireless communication system in accordance with some demonstrative embodiments of the present invention;

FIG. 2 is a schematic illustration of a communication station in accordance with some demonstrative embodiments of the invention;

FIG. 3 is a schematic illustration of a sequence of operations performed by the station of FIG. 2 in accordance with one demonstrative embodiment of the invention;

FIG. 4 is a schematic illustration of a sequence of operations performed by the station of FIG. 2 in accordance with another demonstrative embodiment of the invention; and

FIG. 5 is a schematic flow-chart illustration of a method of transmitting data frames, in accordance with some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Some embodiments of the invention may be implemented, for example, using a machine-readable medium or article which may store an instruction or a set of instructions that, if executed by a machine (for example, by a processor and/or by other suitable machines), cause the machine to perform a method and/or operations in accordance with embodiments of the invention. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

It should be understood that the present invention may be used in a variety of applications. Although the present invention is not limited in this respect, the circuits and techniques disclosed herein may be used in many apparatuses such as units of a wireless communication system, for example, a Wireless Local Area Network (WLAN) communication system and/or in any other unit and/or device. Units of a WLAN communication system intended to be included within the scope of the present invention include, by way of example only, modems, Mobile Units (MU), Access Points (AP), wireless transmitters/receivers, and the like.

Types of WLAN communication systems intended to be within the scope of the present invention include, although are not limited to, WLAN communication systems as described by “IEEE-Std 802.11, 1999 Edition (ISO/IEC 8802-11: 1999)” standard (“the 802.11 standard”), and more particularly in “IEEE-Std 802.11e-2005 Supplement to 802.11-1999, Wireless LAN MAC and PHY specifications: Mediun Access Control (MAC) Quality of Service (QoS) Enhancements” (“the 802.11e standard”), and the like.

Although the scope of the present invention is not limited in this respect, the circuits and techniques disclosed herein may also be used in units of wireless communication systems, digital communication systems, satellite communication systems and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a LAN, wide area network (WAN), or a global communication network, for example, the Internet.

Part of the discussion herein may relate, for exemplary purposes, to transmitting a frame over a channel. However, embodiments of the invention are not limited in this regard, and may include, for example, transmitting a signal, a block, a data portion, a data sequence, a packet, a data signal, a preamble, a signal field, a content, an item, a message, a protection frame, or the like.

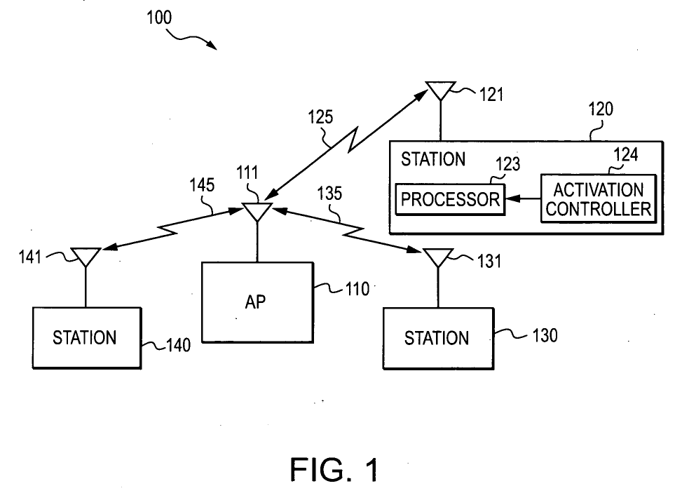

Reference is made to FIG. 1, which schematically illustrates a wireless communication system 100 in accordance with an embodiment of the present invention.

In some demonstrative embodiments of the invention, communication system 100 may include a WLAN system. Although the scope of the present invention is not limited in this respect, communication system 100 may be defined, by the 802.11 standard, as a Basic Service Set (BSS). For example, the BSS may include at least one communication station, for example, an AP 110, and stations 120, 130, and 140 at least one of which may be a MU. In some embodiments, stations 140, 130 and 120 may transmit and/or receive one or more packets over wireless communication system 100. The packets may include data, control messages, network information, and the like. Additionally or alternatively, in other embodiments of the present invention, wireless communication system 100 may include two or more APs, two or more mobile stations, and/or any other communication device, e.g., including a wired device, in which case wireless communication system 100 may be referred to as an extended service set (ESS), as defined by the 802.11 standard, although the scope of the present invention is not limited in this respect.

According to some demonstrative embodiments of the invention, AP 110 may include one or more antennas 111 for transmitting and/or receiving packets, e.g., to/from stations 120, 130 and/or 140. Stations 120, 130 and/or 140 may include one or more antennas 121, 131 and/or 141, respectively, for transmitting and/or receiving packets, e.g., to/from AP 110. Although the scope of the present invention is not limited in this respect, types of antennae that may be used for antennas 111, 121, 131, and/or 141 may include but are not limited to internal antenna, dipole antenna, omni-directional antenna, a monopole antenna, an end fed antenna, a circularly polarized antenna, a micro-strip antenna, a diversity antenna and the like.

According to some demonstrative embodiments of the invention, AP 110 may include suitable WLAN AP communication circuitry, for example, AP circuitry able to operate in accordance with the 802.11 standard and/or any other suitable standard. For example, AP 110 may be able to control communication between AP 110 and stations 120, 130 and/or 140 by sending management commands, e.g., via beacons 125, 135, 145, if desired. For example, AP 110 may implement a Carrier Sense, Multiple Access/Collision Avoidance (CSMA/CA) mechanism, which may include a Request-To-Send/Clear-To-Send (RTS/CTS) mechanism, which may be used to provide collision protection to the transmission of a data frame, if desired.

According to some demonstrative embodiments of the invention, one or more of the stations of system 100, e.g., station 120, may include a processor 123 to process a transmission over a communication channel, e.g., as is known in the art. Processor 123 may be in either an active state of operation, or an inactive state of operation, e.g., as are known in the art. For example, processor 123 may be in the active state while performing a processing operation, e.g., while processing a transmission of a frame, or while processing a received frame. The inactive state may include, for example, a “standby” state, a “sleep” state, a “power down” state, and/or any other state of operation in which processor 123 may consume a reduced amount of electrical power, e.g., compared to the electrical power consumed by processor 123 when in the active state of operation.

According to some demonstrative embodiments of the invention, station 120 may also include an activation controller 124 to allow processor 123 to be in the inactive state of operation during at least a portion of a permitted transmission time period, in which processor 123 is permitted to process a transmission over the communication channel, e.g., as described in detail below. The permitted transmission time period may include a time period determined in accordance with a channel access mechanism implemented by system 100, for example, the CSMA/CA mechanism, e.g., as known in the art.

According to some demonstrative embodiments of the invention, activation controller 124 may be able to manage, e.g., independently of processor 123, the timing for processing the transmission of at least one frame. Activation controller 124 may also selectively activate processor 123 to process the transmission of the frame, e.g., when at least a predetermined portion of the frame is ready for transmission, as described in detail below.

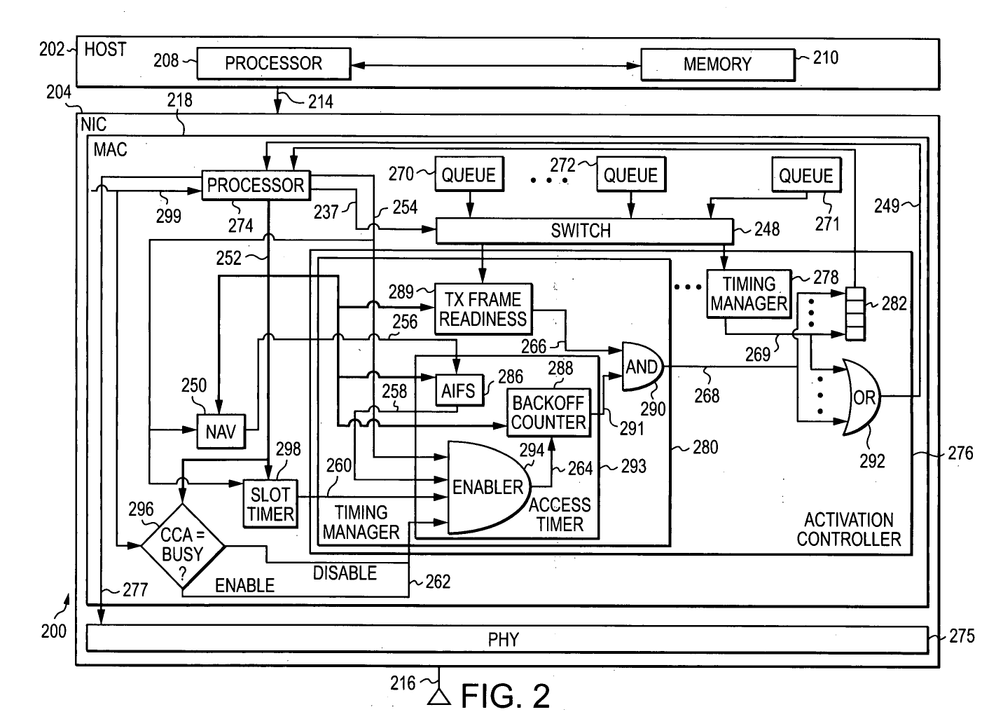

Reference is made to FIG. 2, which schematically illustrates a station 200 in accordance with some demonstrative embodiments of the invention. Although the invention is not limited in this respect, station 200 may be used to perform the functionality of at least one of stations 120, 130 and 140 (FIG. 1).

According to some demonstrative embodiments of the invention, station 200 may include a host 202 associated with a wireless communication module, e.g., a Network Interface Card (NIC) 204, as are described in detail below.

In some embodiments, host 202 may include or may be, for example, a computing platform, e.g., a personal computer, a desktop computer, a mobile computer, a laptop computer, a notebook computer, a terminal, a workstation, a server computer, a Personal Digital Assistant (PDA) device, a tablet computer, a network device, or other suitable computing device.

According to some demonstrative embodiments of the invention, host 202 may include a processor 208 associated with a memory 210. Processor 208 may include, for example, a Central Processing Unit (CPU), a microprocessor, a host processor, a plurality of processors, a controller, a chip, a microchip, or any other suitable multi-purpose or specific processor or controller. Processor 208 may produce signals 214 including one or more transmission (Tx) frames, e.g., as known in the art.

According to some demonstrative embodiments of the invention, the Tx frames may include prioritized Tx frames and/or parameterized Tx frames, e.g., as are. known in the art. For example, the Tx frames may include one or more prioritized Tx frames according to a prioritizing mechanism, e.g., an Enhanced Distributed Channel Access (EDCA) prioritizing mechanism, as defined by the 802.11e standard. The priority of the Tx frames may correspond, for example, to the type of data, e.g., voice data or file data, included within the prioritized Tx frames. Additionally or alternatively, the Tx frames may include one or more parameterized access Tx frames, e.g., according to the Hybrid-Coordination Function (HCF) Controlled Channel Access (HCCA) mechanism as defined by the 802.11e standard.

According to some demonstrative embodiments of the invention NIC 204 may include a Media Access Controller (MAC) 218, a Physical layer (PHY) 275, and one or more antennas 216, as are described below.

According to some demonstrative embodiments of the invention, MAC 218 may include one or more queues, e.g., queues 270, 271, and 272, to queue the Tx frames of signals 214. For example, one or more of the queues, e.g., queues 270 and/or 272, may be provided with Tx frames of one or more, e.g., two, respective priorities. One or more other queues of the plurality of queues may be allocated for queuing the parameterized Tx frames. For example, queue 271 may include a Traffic Specification (TSPEC) queue allocated for queuing HCCA frames, as known in the art. The plurality of queues may include any suitable queues, e.g., First In First Out (FIFO) queues, as are known in the art.

According to some demonstrative embodiments of the invention, MAC 218 may also include a processor 274 able to process the transmission of one or more of the Tx frames over a communication channel, e.g., as is known in the art. For example, processor 274 may provide PHY 277 with processed Tx signals 277 corresponding to the Tx frames, e.g., as known in the art. PHY 275 may include any suitable circuitry and/or hardware, for example, able to modulate signals 277, and transmit the modulated signals and/or other signals, via one or more antennas 216, e.g., as is known in the art.

According to some demonstrative embodiments of the invention, processor 274 may either be in an active state of operation, or an inactive state of operation. For example, processor 274 may be in the active state while performing a processing operation, e.g., while processing a transmission of a frame, or while processing a received frame. The inactive state may include, for example, a “standby” state, a “sleep” state, and/or any other state of operation in which processor 274 may consume a reduced amount of electrical power, e.g., compared to the electrical power consumed by processor 274 when in the active state of operation. Processor 274 may include, for example, a Central Processing Unit (CPU), a Digital Signal Processor (DSP), a microprocessor, a plurality of processors, a controller, a chip, a microchip, or any other suitable multi-purpose or specific processor or controller.

According to some demonstrative embodiments of the invention, MAC 218 may also include an activation controller 276 to allow processor 274 to be in the inactive state of operation during at least a portion of the permitted transmission time period. For example, activation controller 276 may allow processor 274 to be in the inactive stat of operation during one or more time periods in which processor 274 is not required to process a transmission of the one or more Tx frames, e.g., as described below.

According to some demonstrative embodiments of the invention, activation controller 276 may be able to manage, e.g., independently of processor 274, the timing of transmitting the Tx frames within the transmission time period. Activation controller 276 may also selectively activate processor 274 to process a transmission of one or more of the Tx frames, e.g., when at least a predetermined portion of one or more of the Tx frames is ready for transmission, as described in detail below.

According to some demonstrative embodiments of the invention MAC 218 may also include a switch 248, an allocation timer 250, a slot timer 298 and/or a Clear Channel Assessment (CCA) indictor generator 296, e.g., as are described in detail below.

According to some demonstrative embodiments of the invention, allocation timer 250 may measure a time period corresponding to a Network Allocation Vector (NAV) period. For example, timer 250 may include a counter to count down from a first value to a second value according to the NAV period. For example, timer 250 may count down from a first value representing the NAV period, to zero. Timer 250 may also generate an enabling signal 256, e.g., having the value one, for example, when reaching the second value.

According to some demonstrative embodiments of the invention, slot timer 298 may repeatedly measure a slot time period, e.g., 9 milliseconds as defined by “IEEE-Std 802.11g-2003 Supplement to 802.11-1999, Wireless LAN MAC and PHY specifications: Further Higher Data Rate Extension in the 2.4 GHz band” (“the 802.11g standard”). Timer 298 may also generate an enabling signal 260, e.g., having the value one, for example, when the slot time period has ended. Slot timer 298 may include any suitable slot timer, e.g., as is known in the art.

According to some demonstrative embodiments of the invention, generator 296 may receive a CCA signal 299, e.g., as is known in the art. Signal 299 may indicate, for example, that the communication channel is busy; and/or that the channel includes a relatively high level of noise and/or interference, as is known in the art. Generator 296 may generate a signal 262 having a value indicating whether the communication channel may be used for transmission (“channel clear”). For example, signal 262 may include an enabling signal, e.g., having the value one, if signal 299 indicates the channel may be used for transmission; or a disabling signal, e.g., having a zero value, if signal 299 indicates the channel may not be used for transmission.

According to some demonstrative embodiments of the invention, processor 274 may control timer 250, timer 298 and/or generator 296, e.g., using setup signals 252; and/or enable signals 254. For example, processor 274 may provide timer 250 with signals 252 corresponding to the NAV period; slot timer 298 with signals 252 corresponding to the slot time period; and/or generator 296 with signals 252 corresponding to channel assessment parameters, e.g., as known in the art. Processor 274 may activate timer 250, timer 298, and/or generator 296, for example, using signals 254. For example, processor 274 may generate signals 254 having a value one, e.g., at or after the beginning of the permitted transmission time period.

According to some demonstrative embodiments of the invention, activation controller 276 may include a plurality of timing managers, e.g., including timing managers 280 and 278, to manage the timing of the transmission of the plurality of Tx frames during the permitted transmission time period, e.g., independently of processor 274, as described in detail below.

According to some demonstrative embodiments of the invention, the prioritization mechanism implemented by station 200 may include at least one frame transmission priority characterized by one or more priority-related time periods. For example, the 802.11e standard characterizes a frame transmission priority by an Arbitration Inter Frame Space (AIFS) period, a first Contention Window (CW) value, a second CW value, and a random back-off time period corresponding to a random value between the first and second CW values.

According to some demonstrative embodiments of the invention, the plurality of timing managers may correspond to the plurality of prioritized queues. For example, activation controller 276 may include four timing managers, e.g., if MAC includes four priority queues. The plurality of timing managers may manage a plurality of respective access time periods corresponding to the plurality of priorities, as described below.

Managing the timing of the transmission of the plurality of Tx frames independently of processor 274, may allow, fro example, processor 274 to be in the inactive state of operation during at least a portion of the permitted transmission time period, e.g., as described below.

According to some demonstrative embodiments of the invention, switch 248 may selectively associate the plurality of queues with the plurality of timing managers, e.g., as described below.

In some demonstrative embodiments of the invention, processor 274 may control switch 248, e.g., using a control signal 237. For example, processor 274 may control switch 248 to associate manager 280 with a first prioritized queue, e.g., queue 270; and manager 278 with a second prioritized queue, e.g., queue 272. Additionally or alternatively, processor 274 may control switch 248 to associate timing managers 280 and/or 278 with one or more other queues, e.g., one or more parameterized queues. Processor 274 may control switch 248 to associate one or more parameterized queues, e.g., queue 271, with one or more of the timing managers, for example, in order to enable the one or more timing managers to time a transmission of a parameterized Tx frame as a prioritized frame, e.g., as described below with reference to FIG. 4. Switch 248 may include any suitable switching hardware and/or software, e.g., as is known in the art.

According to some demonstrative embodiments of the invention, timing manager 280 may include a frame readiness module 289 to determine whether the queue associated with timing manager 280, e.g., queue 270, includes at least a predetermined Tx frame portion. For example, readiness module 289 may determine whether the length of Tx frame data in queue 270 is longer than a predetermined threshold. The threshold may be set and/or updated by processor 274, e.g., using setup signals 252. Readiness module 289 may generate an enabling signal 266, e.g., having the value one, if queue 270 includes at least the predetermined Tx frame portion. Readiness module 289 may include, for example, any suitable Tx frame readiness machine, e.g., as is known in the art.

According to some demonstrative embodiments of the invention, timing manager 280 may also include an access timer 293 to measure a prioritized access time period corresponding, for example, to the priority of the queue associated with timing manager 280, e.g., as described below.

According to some demonstrative embodiments of the invention, access timer 293 may include an AIFS timer 286 to measure, e.g., while enabled by signal 256, an AIFS period corresponding to the priority queue associated with timing manager 280. Timer 286 may also generate an enabling signal 258, e.g., having the value one, for example, when the AIFS period has ended. For example, timer 286 may include a countdown timer to generate signal 286 after counting down, e.g., from a value corresponding the AIFS period to zero. Processor 274 may set and/or update the AIFS period measured by AIFS timer 286, for example, in accordance with the queue associated with manager 280, e.g., using setup signals 252.

According to some demonstrative embodiments of the invention, access timer 293 may also include an enabler 294 to generate a back-off enabling signal 264 based on enabling signals 258, 254, 260, and/or 262. For example, enabler 294 may include an AND logical gate to generate signal 264, e.g., having the value one, for example, only if each one of signals 254, 258, 260, and 262 has the value one.

According to some demonstrative embodiments of the invention, access timer 293 may also include a back-off counter 288 to measure a random back-off period corresponding to the priority queue associated with timing manager 280. For example, timer 288 may store a back-off value corresponding to the back-off period; and decrease the back-off value, e.g., by one, for example, upon receiving enabling signal 264. Back-off counter 288 may also generate an enabling signal 291, e.g., having the value one, for example, after the back-off period has ended, e.g., when the back-off value is zero. Back-off counter 288 may determine the back-off period, for example, based on first and second CW values, e.g., minimum and maximum CW values, corresponding to the priority queue associated with timing manager 280. Processor 274 may set and/or update the first and second CW values used by back-off counter 288, for example, in accordance with the queue associated with manager 280, e.g., using setup signals 252.

Thus, in accordance with the above description timer 250 may be activated by processor 274 to measure the NAV period; AIFS timer may be activated, e.g., by signal 256, to measure the AIFS period after the NAV period has ended; enabler 294 may activate back-off counter 288, e.g., using signal 264, to decrease the back-off value, e.g., upon slot timer 298 reaching the zero value and while signals 254 and 262 are enabled; and timer 288 may generate signal 291 after the back-off period has ended.

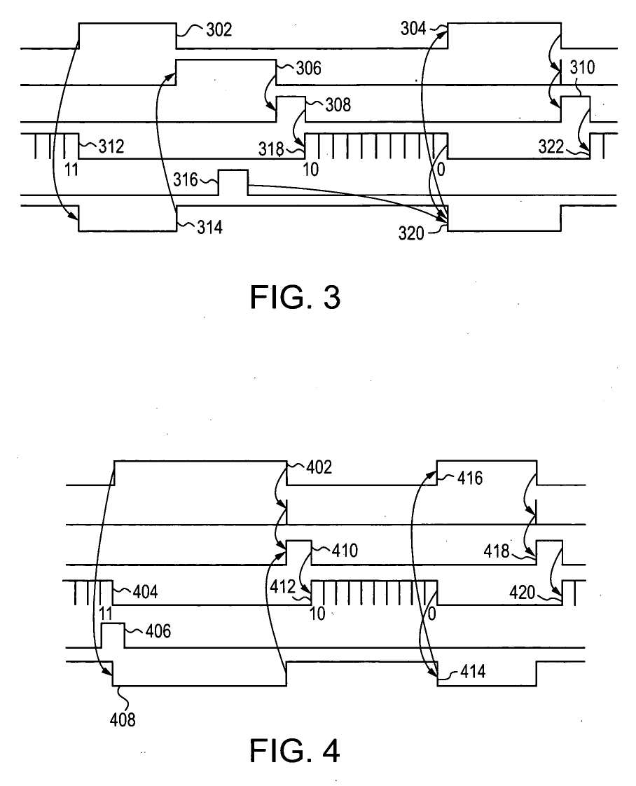

According to some demonstrative embodiments of the invention, processor 274 may set timer 250 to measure a NAV period, e.g., corresponding to a received frame, for example, while back-off counter is measuring the back-off period. As a result, timer 250 may disable timer 286, e.g., until the NAV period ends. Timer 286, in turn, may disable enabler 294, e.g., until the AIFS period ends. Accordingly, back-off counter 288 may be halted, for example, until the NAV period and the AIFS periods have passed, e.g., as described below with reference to FIG. 3.

According to some demonstrative embodiments of the invention, timing manager 280 may also include an AND logical gate 290 to generate a transmission-enable signal 268 based on signals 266 and 291. For example, AND gate 290 may generate signal 268 having the value one, e.g., if both signals 268 and 291 have the value one. Accordingly, gate 290 may generate signal 268 if, for example, the back-off period has ended, and queue 270 is determined to include the predetermined Tx frame portion.

According to some demonstrative embodiments of the invention, one or more other timing managers of the plurality of timing managers, e.g., timing manager 278, may be able to generate one or more respective transmission-enable signals, e.g., signal 269, analogously to timing manager 280. For example, timing manager 278 may include a frame readiness module, e.g., analogous to readiness module 284; an access timer to measure a prioritized access time period corresponding to a queue associated with timing manager 278, e.g., in analogy to access timer 293; and an AND logic gate, e.g., analogous to AND gate 290.

According to some demonstrative embodiments of the invention, activation controller 276 may also include a priority register 282 to store a plurality of values corresponding to the plurality of transmission-enable signals, respectively. For example, register 282 may include a plurality of addresses corresponding to the plurality of timing managers, respectively. The plurality of addresses of register 282 may store a plurality of values corresponding to the plurality of transmission-enable signals, respectively. For example, register 282 may include first and second addresses to store first and second values corresponding to signals 268 and 269, respectively. The values stored in the plurality of addresses may indicate, for example, whether processor 274 may be allowed to process the transmission of one or more Tx frames in one or more of the plurality of queues. For example, a value one stored in an address of register 282 corresponding to timing manager 280 may indicate that processor 274, may be allowed to process the transmission of one or more Tx frames in a queue associated with timing manager 280, e.g., queue 270.

According to some demonstrative embodiments of the invention, activation controller 276 may also include an OR logical gate to generate a transmission interrupt signal 249 based on the plurality of transmission-enable signals. For example, signal 249 may have the value one if one or more of the plurality of transmission-enable signals has the value one. Accordingly, signal 249 may indicate whether processor 274 may be activated to process the transmission of at least one of the Tx frames in the plurality of queues.

According to some demonstrative embodiments of the invention, activation signal 249 may activate processor, e.g., to process a transmission of one or more of the Tx frames, as described below.

According to some demonstrative embodiments of the invention, processor 274 may determine a queue from which to process the transmission of a Tx frame, e.g., based on the values stored in register 282. Processor 274 may process, for example, the transmission of Tx frames of queues indicated by one or more addresses of register 282, e.g., in an order corresponding to hierarchy of the priorities corresponding to the queues. For example, when processor 274 is activated by interrupt signal 249, the values stored in register 282 may indicate that processor 274 may process transmission from two or more queues (“the enabled queues”), e.g., queues 270 and 272. Processor 274 may process transmission of a Tx frame in a first queue, e.g., queue 270, corresponding to a first priority, before processing the transmission of Tx frame in a second queue, e.g., queue 272, corresponding to a second priority, e.g., lower than the first priority.

Reference is also made to FIG. 3, which schematically illustrates a sequence of operations performed by the station of FIG. 2 in accordance with one demonstrative embodiment of the invention.

Although the invention is not limited in this respect, the sequence of operations illustrated in FIG. 3, may be performed by station 200, for example, to transmit one or more prioritized Tx frames over a channel. For example, the Tx frames may include a voice data frame having a priority corresponding to an Access Category (AC) AC_V0, e.g., as defined by the 802.11e standard. The back-off period corresponding to AC_V0 may equal, for example, fifteen time slots.

As illustrated in FIG. 3, back-off counter 288 may measure a period 312 corresponding to five time slots, for example, before being disabled by enabler 294. For example, generator 296 may generate signal 262 indicating that the channel may not be used for transmission during a time period 302. Accordingly, enabler 294 may selectively disable back-off counter 288, e.g., during time period 302.

According to some demonstrative embodiments of the invention, time period 302 may include a time period for receiving a signal over the channel. Processor 274 may process the received signal and determine a NAV period corresponding to the received signal, e.g., during a time period 314. Processor 274 may set timer 250, e.g., using signals 252, to measure the NAV period. As illustrated in FIG. 3, NAV timer 250 may measure a period 306 corresponding to the NAV period.

As illustrated in FIG. 3, timer 286 may measure an AIFS period 308 upon receiving signal 256, e.g., after NAV period 306.

As illustrated in FIG. 3, back-off counter 288 may be enabled, e.g., after AIFS period 308 has ended. Back-off counter 288 may then measure a period 318 corresponding to the ten remaining time slots.

As illustrated in FIG. 3, module 289 may determine during a time period 316 that the queue associated with timing manager 280, e.g., queue 270, includes at least the predetermined Tx frame portion.

As illustrated in FIG. 3, activation controller 276 may generate interrupt signal 249 to activate processor 274, e.g., after the back-off period has ended. Processor 274 may process transmission of the Tx frame during a time period 320.

According to the above description, processor 274 may be allowed to be in the inactive state of operation between time periods 314 and 320.

As illustrated in FIG. 3, generator 296 may generate signal 262 indicating the channel may not be used for transmission during a time period 304, e.g., corresponding to time period 320. AIFS timer 286 may measure an AIFS period 310, e.g., after period 304; and back-off counter 288 may measure the back-off period 322, e.g., after period 310.

According to some demonstrative embodiments of the invention, after processing the transmission of the Tx frame, processor 274 may be allowed to be in the inactive state of operation, e.g., until transmission of another Tx frame is enabled, and/or a signal is received over the channel.

Reference is also made to FIG. 4, which schematically illustrates a sequence of operations performed by the station of FIG. 2 in accordance with another demonstrative embodiment of the invention.

Although the invention is not limited in this respect, the sequence of operations illustrated in FIG. 4, may be performed by station 200, for example, to transmit one or more parameterized Tx frames over a channel. For example, the Tx frames may include a voice data frame to be transmitted using the HCCA mechanism. The Tx frame may be queued in a TSPEC queue allocated for queuing HCCA frames, e.g., queue 271. The back-off period corresponding to the Tx frame may equal, for example, fifteen time slots.

As illustrated in FIG. 4, processor 274 may attempt to transmit the Tx frame using the HCCA mechanism during a time period 408. The transmission of the Tx frame using the HCCA mechanism may fail, for example, due to not receiving an Acknowledgment (ACK) response during an allocated Tx period 402.

As illustrated in FIG. 4, the time period 408 may occur, for example, after back-off counter 288 had measured a period 404 corresponding to five time slots.

As illustrated in FIG. 4, according to some demonstrative embodiments of the invention, processor 274 may control switch 248 to associate queue 271 with a timing manager, e.g., timing manager 280, corresponding to the priority of the Tx frame. Processor 274 may also set AIFS timer 286 to measure an AIFS period corresponding to the priority of the Tx frame.

As illustrated in FIG. 4, timer 286 may measure a period 410 corresponding to the AIFS period, e.g., after period 402, for example, since the NAV period may be equal to zero.

As illustrated in FIG. 4, back-off counter 288 may be enabled, e.g., after AIFS period 410. Back-off counter 288 may then measure a period 412 corresponding to the ten remaining time slots.

As illustrated in FIG. 4, module 289 may determine during a time period 406 that queue 271, includes at least the predetermined Tx frame portion.

As illustrated in FIG. 4, activation controller 276 may generate interrupt signal 249 to activate processor 274, e.g., after period 412. Processor 274 may process transmission of the Tx frame during a time period 414.

According to the above description, processor 274 may be allowed to be in the inactive state of operation between time periods 408 and 414.

As illustrated in FIG. 4, generator 296 may generate signal 262 indicating the channel may not be used for transmission during a time period 416, e.g., corresponding to period 414. AIFS timer 286 may measure an AIFS period 418, e.g., after period 416; and back-off counter 288 may measure the back-off period 420, e.g., after period 418.

According to some demonstrative embodiments of the invention, after processing the transmission of the Tx frame, processor 274 may be allowed to be in the inactive state of operation, e.g., until transmission of another Tx frame is enabled, and/or a signal is received over the channel.

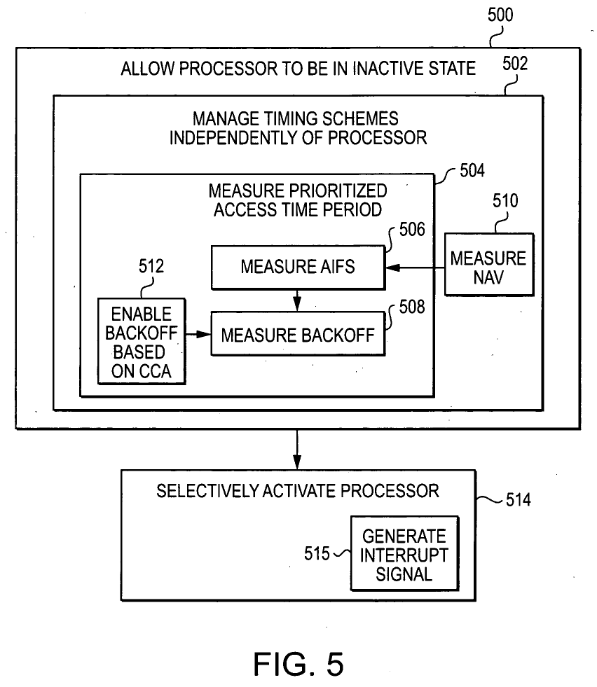

Reference is now made to FIG. 5, which schematically illustrates a method of transmitting one or more frames in accordance with some demonstrative embodiments of the invention.

As indicated at block 500, in some demonstrative embodiments of the invention the method may include allowing a processor to be in an inactive state of operation during at least a portion of a permitted transmission time period in which the processor is permitted to process a transmission over a wireless communication channel.

As indicated at block 514, in some demonstrative embodiments of the invention the method may include selectively activating the processor to process a transmission of at least one frame over the channel when at least a predefined portion of the frame is ready for transmission. For example, the method may include selectively generating a transmission interrupt signal to cause the processor to switch from the inactive state to an active state of operation, as indicated at block 515.

As indicated at block 502, in some demonstrative embodiments of the invention the method may include managing, e.g., independently of the processor, a plurality of timing schemes to determine times of transmission of a plurality of frames during the permitted transmission time period.

As indicated at block 504, in some demonstrative embodiments of the invention managing the timing schemes may include measuring, e.g., independently of the processor, a prioritized access time period corresponding to a priority of a frame of the plurality of frames.

As indicated at block 506, in some demonstrative embodiments of the invention measuring the access time period may include measuring an AIFS period corresponding to the priority of the frame. The method may also include, for example, measuring a random back-off period corresponding to the priority of the frame, e.g., after measuring the AIFS period, as indicated at block 508.

As indicated at block 512, in some demonstrative embodiments of the invention measuring the access time period may also include selectively enabling the measuring of the back-off period based on an assessment of the channel.

As indicated at block 510, in some demonstrative embodiments of the invention the method may also include measuring, e.g., independently of the processor, a NAV period. The access time period may be measured, e.g., after measuring the NAV period.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus comprising:
an activation controller to selectively activate a processor to process a transmission of at least one frame over a wireless communication channel when at least a predefined portion of said frame is ready for transmission,
wherein said processor is in an inactive state of operation during at least a portion of a permitted transmission time period during which said processor is permitted to process a transmission over said channel.

2. The apparatus of claim 1, wherein said activation controller is able to selectively generate a transmission interrupt signal to cause said processor to switch from said inactive state to an active state of operation.

3. The apparatus of claim 1, wherein said at least one frame comprises a plurality of frames of one or more priorities, said activation controller comprises one or more timing managers to manage, independently of said processor, the timing for transmission of said plurality of frames during said permitted transmission time period.

4. The apparatus of claim 3, wherein said timing manager comprises an access timer to measure, independently of said processor, a prioritized access time period corresponding to a priority of a frame of said plurality of frames, and wherein said activation controller is able to activate said processor after said access time period.

5. The apparatus of claim 4, wherein said access timer comprises:
an arbitration timer to measure an arbitration-inter-frame-space period corresponding to the priority of said frame;
a back-off counter to measure a random back-off period corresponding to the priority of said frame; and
an enabler to enable said back-off counter to measure said back-off period after said arbitration-inter-frame-space period.

6. The apparatus of claim 5 comprising a generator to generate an indication of an assessment of said channel, wherein said enabler is able to selectively disable said back-off counter based on said indication.

7. The apparatus of claim 4 comprising an allocation timer to measure, independently of said processor, a network allocation vector period, and to enable said arbitration timer to measure said arbitration-inter-frame-space period after said network allocation vector period.

8. The apparatus of claim 3 comprising:
a plurality of queues to queue said plurality of frames; and
a switch to associate one or more of said plurality of queues with one or more of said timing managers.

9. The apparatus of claim 8, wherein said plurality of queues comprises one or more parameterized queues.

10. A method comprising:
selectively activating a processor to process a transmission of at least one frame over a wireless communication channel when at least a predefined portion of said frame is ready for transmission; and
allowing said processor to be inactive during at least a portion of a permitted transmission time period during which said processor is permitted to process a transmission over said channel.

11. The method of claim 10, wherein selectively activating said processor comprises selectively providing said processor with a transmission interrupt signal.

12. The method of claim 10, wherein selectively activating said processor to process the transmission of said at least one frame comprises selectively activating said processor to process the transmission of a plurality of frames of one or more priorities, said method comprises managing, independently of said processor, a plurality of timing schemes to determine times of transmission of said plurality of frames during said permitted transmission time period.

13. The method of claim 12 comprising measuring, independently of said processor, a prioritized access time period corresponding to a priority of a frame of said plurality of frames, wherein selectively activating said processor comprises selectively activating said processor after measuring said access time period.

14. The method of claim 13, wherein measuring said access time period comprises:
measuring an arbitration-inter-frame-space period corresponding to the priority of said frame; and
measuring a random back-off period corresponding to the priority of said frame after measuring said arbitration-inter-frame-space period.

15. The method of claim 14 comprising selectively enabling the measuring of said back-off period based on an assessment of said channel.

16. The method of claim 13 comprising measuring, independently of said processor, a network allocation vector period, and wherein measuring said access time period comprises starting to measure said access time period after measuring said network allocation vector period.

17. A wireless transmission system comprising:
a wireless station including:
an activation controller to selectively activate a processor to process a transmission of at least one frame over a wireless communication channel when at least a predefined portion of said frame is ready for transmission, wherein said processor is in an inactive state of operation during at least a portion of a permitted transmission time period during which said processor is permitted to process a transmission over said channel; and
one or more dipole antennas to transmit said frame.

18. The wireless transmission system of claim 17, wherein said at least one frame comprises a plurality of frames of one or more priorities, said activation controller comprises one or more timing managers to manage, independently of said processor, the timing for transmission of said plurality of frames during said permitted transmission time period.

19. The wireless transmission system of claim 18, wherein said timing manager comprises an access timer to measure, independently of said processor, a prioritized access time period corresponding to a priority of a frame of said plurality of frames, and wherein said activation controller is able to activate said processor after said access time period.

20. The wireless transmission system of claim 18 comprising:
a plurality of queues to queue said plurality of frames; and
a switch to associate one or more of said plurality of queues with one or more of said plurality of said timing managers.

21. The wireless transmission system of claim 17 comprising another wireless station to receive said frame.
